(19) United States
(12) Patent Application Publication
(10) Pub. No.: US 2025/0271743 A1
(43) Pub. Date: Aug. 28, 2025

(54) ELECTRONIC APPARATUS AND CONTROLLING METHOD THEREOF

(71) Applicant: SAMSUNG ELECTRONICS CO., LTD., Suwon-si (KR)

(72) Inventors: Taehyeong KIM, Suwon-si (KR); Taehee LEE, Suwon-si (KR); Junghoe KIM, Suwon-si (KR)

(73) Assignee: SAMSUNG ELECTRONICS CO., LTD., Suwon-si (KR)

(21) Appl. No.: 19/067,137

(22) Filed: Feb. 28, 2025

Related U.S. Application Data
(63) Continuation of application No. PCT/KR2024/020720, filed on Dec. 19, 2024.

(30) Foreign Application Priority Data
Feb. 27, 2024 (KR) 10-2024-0027807

(51) Int. Cl. G03B 21/20; G06T 7/00

(52) U.S. Cl. CPC G03B 21/2046; G06T 7/0002; G06T 2207/30168

(57) ABSTRACT

An electronic apparatus includes: a sensor; a projection apparatus configured to project a projection image; a moving device including at least one actuator and configured to move the electronic apparatus; memory storing at least one instruction; and at least one processor configured to execute the at least one instruction, wherein the at least one instruction, when executed by the at least one processor, causes the electronic apparatus to: obtain position information of a user and direction information of the user based on a sensing value of the sensor; identify a projection area based on the position information and the direction information; identify an image projection position of the electronic apparatus based on an image projection distance and an image projection angle with respect to the projection area; and control the moving device to move to the image projection position.

### CROSS-REFERENCE TO RELATED APPLICATIONS

This application is a continuation of International Application No. PCT/KR2024/020720 designating the United States, filed on Dec. 19, 2024, in the Korean Intellectual Property Receiving Office and claiming priority to Korean Patent Application No. 10-2024-0027807, filed on Feb. 27, 2024, in the Korean Intellectual Property Office, the disclosures of each of which are incorporated by reference herein in their entireties.

### BACKGROUND

### 1. Field

The present disclosure relates to an electronic apparatus and a controlling method thereof and more particularly, to an electronic apparatus identifying an image projection position and projecting an image and a controlling method thereof.

### 2. Description of Related Art

A projector is an electronic apparatus projecting an input image signal on a screen by using light emitted from a light source (e.g., a light-emitting diode (LED) or a lamp) to show an image.

Recently, a movable projector has been commercialized and a user may project an image on a desired projection area by projecting the image after positioning the projector at an optimum image projection position.

### SUMMARY

According to an aspect of the disclosure, an electronic apparatus includes: a sensor; a projection apparatus configured to project a projection image; a moving device including at least one actuator and configured to move the electronic apparatus; memory storing at least one instruction; and at least one processor configured to execute the at least one instruction, wherein the at least one instruction, when executed by the at least one processor, causes the electronic apparatus to: obtain position information of a user and direction information of the user based on a sensing value of the sensor; identify a projection area based on the position information and the direction information; identify an image projection position of the electronic apparatus based on an image projection distance and an image projection angle with respect to the projection area; and control the moving device to move to the image projection position.

The memory may store information about a surrounding space of the user, and the at least one instruction, when executed by the at least one processor, may cause the electronic apparatus to: generate a cost map including a plurality of costs and a plurality of grids corresponding to each of the plurality of costs based on the image projection distance, the image projection angle, and the information about the surrounding space; and identify the image projection position as a position corresponding to a grid of the plurality of grids having a smallest cost among the plurality of costs.

The at least one instruction, when executed by the at least one processor, may cause the electronic apparatus to: generate a first layer having a first cost that decreases from a grid of the plurality of grids having a first difference between the image projection distance and a preset distance to a grid of the plurality of grids having a second difference between the image projection distance and the preset distance, the second difference being larger than the first distance; generate a second layer having a second cost that decreases from a grid of the plurality of grids having a third difference between the image projection angle and a preset angle to a grid of the plurality of grids having a fourth difference between the image projection angle and the preset angle, the fourth difference being larger than the third difference; and generate the cost map by assigning a weight value to each of the first layer and the second layer.

The memory stores preferred position information corresponding to status of the user, and the at least one instruction, when executed by the at least one processor, may cause the electronic apparatus to: obtain status information of the user based on the sensing value of the sensor; identify a plurality of candidate positions in which the image projection angle with respect to the projection area is within a preset angle range and the image projection distance is within a preset distance range; and identify the image projection position among the plurality of candidate positions based on the status information of the user and the preferred position information.

The sensor includes a camera, and the at least one instruction, when executed by the at least one processor, may cause the electronic apparatus to: control the moving device to move to the image projection position based on feedback of the user with respect to movement to the image projection position obtained through the camera.

The at least one instruction, when executed by the at least one processor, may cause the electronic apparatus to: based on the image projection position being changed, compare an image quality of the projection image at a position before changing to an image quality of the projection image at a position after changing, and provide information about a change in image quality of the projection image based on the comparison.

The electronic apparatus may further include a microphone, and the at least one instruction, when executed by the at least one processor, may cause the electronic apparatus to: control the moving device to move to the image projection position based on feedback of the user with respect to movement to the image projection position obtained through the microphone.

The at least one instruction, when executed by the at least one processor, may cause the electronic apparatus to: update the plurality of costs of the cost map based on feedback of the user with respect to movement of the image projection position being obtained; and identify the smallest cost among the plurality of costs in the updated cost map and change the image projection position to a position corresponding to a grid including the smallest cost in the updated cost map.

The at least one instruction, when executed by the at least one processor, may cause the electronic apparatus to identify the projection area based on a type of contents corresponding to the projection image and a playback time.

The sensor may include a camera, and the at least one instruction, when executed by the at least one processor, may cause the electronic apparatus to: control the camera to photograph a surrounding space of the user; and obtain information about a plurality of projectable areas within the surrounding space based on the photographed surrounding space.

According to an aspect of the disclosure, a method of controlling an electronic apparatus, includes: obtaining position information of a user and direction information of the user based on a sensing value of a sensor; identifying a projection area based on the position information and the direction information; identifying an image projection position of the electronic apparatus based on an image projection distance and an image projection angle with respect to the projection area; and moving to the image projection position.

The identifying the image projection position may include: generating a cost map including a plurality of costs and a plurality of grids corresponding to each of the plurality of costs based on the image projection distance, the image projection angle, and the information about a surrounding space of the user; and identifying the image projection position as a position corresponding to a grid of the plurality of grids having a smallest cost among the plurality of costs.

The generating the cost map may include: generating a first layer having a first cost that decreases from a grid of the plurality of grids having a first difference between the image projection distance and a preset distance to a grid of the plurality of grids having a second difference between the image projection distance and the preset distance, the second difference being larger than the first distance; generating a second layer having a second cost that decreases from a grid of the plurality of grids having a third difference between the image projection angle and a preset angle to a grid of the plurality of grids having a fourth difference between the image projection angle and the preset angle, the fourth difference being larger than the third difference; and generating the cost map by assigning a weight value to each of the first layer and the second layer.

The identifying the image projection position may include: obtaining status information of the user based on the sensing value of the sensor; identifying a plurality of candidate positions in which the image projection angle with respect to the projection area is within a preset angle range and the image projection distance is within a preset distance range; and identifying the image projection position based on the status information of the user and preferred position information corresponding to status of the user.

According to an aspect of the disclosure, a non-transitory computer readable recording medium stores computer instructions that when executed by a processor of an electronic apparatus, cause the electronic apparatus to: obtain position information of a user and direction information of the user based on a sensing value of a sensor; identify a projection area based on the position information and the direction information; identify an image projection position of the electronic apparatus based on an image projection distance and an image projection angle with respect to the projection area; and move to the image projection position.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating operations of an electronic apparatus according to one or more embodiments;

FIG. 2 is a view illustrating a configuration of an electronic apparatus according to one or more embodiments;

FIG. 3 is a block diagram illustrating a configuration of an electronic apparatus according to one or more embodiments;

FIG. 4A is a view illustrating a method of identifying an image projection area of an electronic apparatus according to one or more embodiments;

FIG. 4B is a view illustrating a method of identifying an image projection area of an electronic apparatus according to one or more embodiments;

FIG. 5 is a view illustrating a method of generating a cost map of an electronic apparatus according to one or more embodiments;

FIG. 6 is a view illustrating a method of generating a cost map based on a plurality of layers of an electronic apparatus according to one or more embodiments;

FIG. 7A is a view illustrating an operating method based on feedback of a user of an electronic apparatus according to one or more embodiments;

FIG. 7B is a view illustrating an operating method based on feedback of a user of an electronic apparatus according to one or more embodiments;

FIG. 8A is a view illustrating a method of providing information about a change of image quality of an electronic apparatus according to one or more embodiments;

FIG. 8B is a view illustrating a method of providing information about a change of image quality of an electronic apparatus according to one or more embodiments;

FIG. 9 is a flow chart illustrating a method of moving to an image projection position of an electronic apparatus according to one or more embodiments;

FIG. 10 is a flow chart illustrating a method of identifying an image projection position of an electronic apparatus according to one or more embodiments; and

FIG. 11 is a flow chart illustrating operations about feedback of a user of an electronic apparatus according to one or more embodiments.

### DETAILED DESCRIPTION

Embodiments of the disclosure may be modified in various different forms and may have various embodiments, wherein specific embodiments will be exemplified in the drawings and specifically explained in the detailed description. However, it should be noted that the various embodiments are not for limiting the scope of the disclosure to a specific embodiment but should be interpreted to include all modifications, equivalents, and/or alternatives of the embodiments of the disclosure. With respect to the detailed description of the drawings, similar components may be designated by similar reference numerals.

In case it is determined that in describing the disclosure, detailed explanation of related known functions or features may unnecessarily confuse the gist of the disclosure, the detailed explanation will be omitted.

In addition, the embodiments below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

The terms used in the disclosure are used only to explain specific embodiments and are not intended to limit the scope of the disclosure. Singular expressions include plural expressions, unless defined obviously differently in the context.

In the disclosure, expressions such as “have,” “may have,” “include” or “may include” denote the existence of such characteristics (e.g. elements such as numerical values, functions, operations, and parts) and the expressions do not exclude the existence of additional characteristics.

In the disclosure, the expressions “A or B”, “at least one of A and/or B”, “one or more of A and/or B” or the like may include all possible combinations of the listed items. For example, “A or B”, “at least one of A and B”, or “at least one of A or B” may refer to all of the following cases: (1) including at least one A, (2) including at least one B, or (3) including all of at least one A and at least one B.

The expressions “1st”, “2nd”, “first,” “second” or the like used in the disclosure may describe various elements regardless of any order and/or degree of importance. Such expressions are used only to distinguish one element from another element and are not intended to limit the elements.

The description in the disclosure that one element (e.g. a first element) is “(operatively or communicatively) coupled with/to” or “connected to” another element (e.g. a second element) should be interpreted to include both the case where the one element is directly coupled to the another element, and the case where the one element is coupled to the another element through the other element (e.g.: a third element).

In contrast, the description that one element (e.g. a first element) is “directly coupled” or “directly connected” to another element (e.g. a second element) may be interpreted to mean that the other element (e.g. a third element) is not present between the one element and another element.

The expression “configured to (or set to)” used in the disclosure may be interchangeably used with other expressions, for example, “suitable for”, “having the capacity to”, “designed to”, “adapted to”, “made to”, or “capable of” depending on cases. The term “configured to (or set to)” may not necessarily mean that a device is “specifically designed to” in terms of hardware.

Instead, under some circumstances, the expression “a device configured to” may mean that the device “is capable of” performing an operation together with another device or component. For example, the phrase “a processor configured to (set to) perform A, B, and C” may mean a dedicated processor for performing the corresponding operations (e.g. an embedded processor), or a generic-purpose processor that can perform the corresponding operations by executing one or more software programs stored in a memory device (e.g.: a CPU or an application processor).

In embodiments of the disclosure, ‘module’ or ‘part’ may perform at least one function or operation, and may be implemented as hardware or software, or as a combination of hardware and software. In addition, a plurality of ‘modules’ or ‘parts’ may be integrated into at least one module and implemented as at least one processor excluding ‘module’ or ‘part’ that needs to be implemented as specific hardware.

According to various embodiments, operations performed by a module, a program, or another component may be executed sequentially, in parallel, repetitively, or heuristically, or at least part of the operations may be executed in different orders or be omitted, or another operation may be added.

Various elements and areas in the drawings were illustrated schematically. Accordingly, the technical idea of the disclosure is not limited by the relative sizes or intervals illustrated in the appended drawings.

An electronic apparatus according to various embodiments of the disclosure may include at least one of, for example, a smart phone, a tablet PC, a desktop PC, a laptop PC, or a wearable device. The wearable device may include at least one of an accessory type circuit (e.g. a watch, a ring, a bracelet, an anklet, a necklace, glasses, contact lenses, or a head-mounted-device (HMD)), a fabric or clothing-integrated circuit (e.g. an electronic garment), a body attachable circuit (e.g. a skin pad or a tattoo), or a body implantable circuit.

In some examples, the electronic apparatus may include at least one of, for example, a television, a digital video disk (DVD) player, an audio, a refrigerator, an air conditioner, a vacuum cleaner, an oven, a microwave, a washing machine, an air purifier, a set-top box, a home automation control panel, a security control panel, a media box (e.g. Samsung HomeSync™, Apple TV™, or Google TV™), a game console (e.g. Xbox™, PlayStation™), an electronic dictionary, an electronic key, a camcorder, or an electronic picture frame. On one hand, an apparatus having a display among the aforementioned electronic apparatuses may be referred to as a display apparatus. On the other hand, the electronic apparatus of the disclosure may be a set-top box or a PC providing the display apparatus with an image even though the display is not included.

Hereinafter, with reference to the appended drawings, an embodiment according to the disclosure is specifically described to be easily embodied by those skilled in the art.

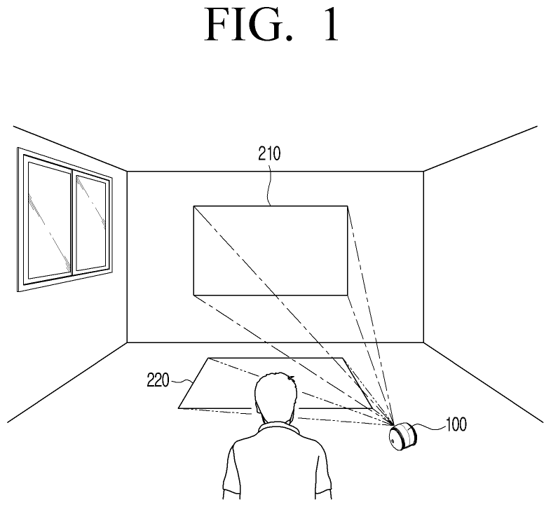

FIG. 1 is a view illustrating operations of an electronic apparatus according to one or more embodiments.

According to FIG. 1, an electronic apparatus 100 may identify projection areas 210, 220 based on position information and direction information of the user.

Here, “position information of the user” means various information about a user position identified by the electronic apparatus 100. For example, the user information of the user may include a 2-dimension or 3-dimension coordinate value. In this case, the position information of the user may be expressed as a specific coordinate value of a 2-dimension or 3-dimension coordinate system having a starting point at any one point in a building.

Here, “direction information of the user” means various information about a user direction identified by the electronic apparatus 100. For example, the direction information of the user may include angle information about a body direction including an upper body or a face of the user. In this case, the direction information of the user may be determined based on an angle at which the direction of the body of the user rotates with respect to any axis. According to another example, the direction information of the user may include vector information about the direction of the body of the user.

According to an embodiment, if the position information of the user corresponds to information of being located at an opposite side of a wall and the direction information of the user corresponds to a direction of the wall, the electronic apparatus 100 may identify a first projection area 210 as a projection area.

According to another embodiment, if the position information of the user corresponds to information of being located at an opposite side of a wall and the direction information of the user corresponds to a direction of a bottom, the electronic apparatus 100 may identify a second projection area 220 as a projection area.

The electronic apparatus 100 of the disclosure may store information about a plurality of projectable areas existing in a space. Here, “projectable area” means an area onto which the electronic apparatus 100 may project an image. For example, the projectable areas may include the wall, the bottom, or a ceiling existing in the space. According to still another example, the projectable area may include an area which may provide an uninterrupted image to the user such as not only the wall or the bottom but also an area where a screen is installed, a furniture area, or a blind area. Also, “information about a plurality of projectable areas” may include information about a position of each of the plurality of projectable areas, planarity of each of the plurality of projectable areas, a color of each of the plurality of projectable areas, etc.

The electronic apparatus 100 of the disclosure may capture a surrounding space of the user and obtain information about the plurality of projectable areas. Specifically, if the electronic apparatus 100 includes a camera, it may control the camera to photograph the surrounding space of the user and obtain information about the plurality of projectable areas in the surrounding space.

According to an embodiment, if the electronic apparatus 100 obtains an image output command from the user, it may identify a projection area based on the information about the plurality of projectable areas pre-stored in the electronic apparatus 100, the position information of the user, and the direction information of the user. According to another embodiment, if the electronic apparatus 100 obtains the image output command from the user, it may scan the surrounding space of the user, obtain information about the plurality of projectable areas, and then identify a projection area.

FIG. 1 illustrates a projection area in a rectangular form but it is merely one example, wherein it is obvious that the projection area may be implemented in various forms such as a circle, a parallelogram, or a rhombus.

In the detailed description, it is described that the information about the plurality of projectable areas may be obtained by using the camera but it is merely one example, wherein it is obvious that information about the plurality of projectable areas may be obtained based on various sensors such as a light detection and ranging (“lidar”) sensor and a time of flight (“ToF”) sensor. Also, the electronic apparatus 100 may obtain the information about the plurality of projectable areas from an external electronic apparatus such as a robot cleaner and a robot.

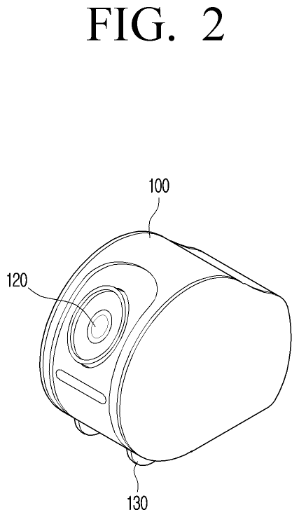

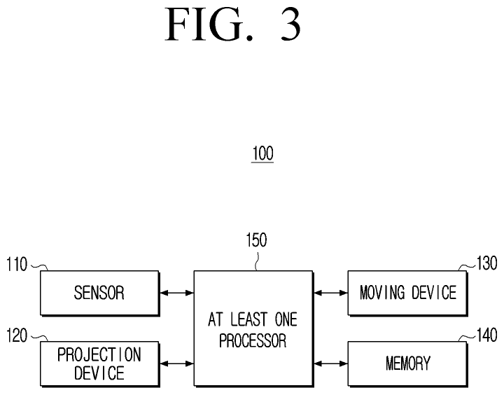

As aforementioned, the electronic apparatus 100 determines an optimum projection area based on the position, the direction, and the like of the user and thus may reduce inconvenience that the user must change the position or the direction of himself/herself for viewing an image. Also, the electronic apparatus 100 may determine an optimum image projection area based on information about the plurality of projectable areas and thus may provide the user with an image having high image quality. In the description part with respect to FIGS. 2 and 3 below, operations of the electronic apparatus 100 are specifically described together with the description about a configuration of the electronic apparatus 100.

FIG. 2 is a view illustrating a configuration of an electronic apparatus according to one or more embodiments.

According to FIG. 2, the electronic apparatus 100 having a movable form is illustrated. The above is merely one example of shown forms and it may have a shape different from the shown form.

The electronic apparatus 100 may include a projection device 120 on its front. According to FIG. 2 as shown, the projection device 120 is located on the front of the electronic apparatus 100 but it is merely one example, wherein the projection device 120 may be located at various positions such as its rear, and its upper part of the electronic apparatus 100.

According to FIG. 2 as shown, the projection device 120 is of a projector type projecting and displaying an image. Accordingly, the electronic apparatus 100 may project an image onto a projection area to provide the user with the image.

Hereinafter, the description is made under the assumption that the projection device 120 projects the image in a projector type. However, upon implementing, the projection device 120 may be implemented as a configuration displaying the image on a specific side of the electronic apparatus (e.g. a LCD, an OLED, a micro LED, etc.) rather than the projector type. On one hand, in the shown example, one projection device 120 is disposed on the front of the electronic apparatus 100 but upon implementing, a plurality of projection devices may be disposed in the electronic apparatus 100.

The electronic apparatus 100 may include a moving device 130 on its lower part. The moving device 130 is a component for moving the electronic apparatus 100. For the above, the moving device 130 may include an actuator such as a motor, a wheel, and the like and move the electronic apparatus 100 through movement of the wheel. The moving device 130 may be implemented in various forms, wherein examples in which the moving device 130 may be implemented in various forms are specifically described in the description part with respect to FIG. 3 below.

The shown form of the electronic apparatus 100 is merely one example and it may be implemented in various forms. A specific configuration composing the electronic apparatus 100 is after-mentioned with reference to FIG. 3.

FIG. 3 is a block diagram illustrating a configuration of an electronic apparatus according to one or more embodiments.

According to FIG. 3, the electronic apparatus 100 may include a sensor 110, a projection device 120, a moving device 130, memory 140, and at least one processor 150.

The sensor 110 may sense a user and a surrounding space of the user. For example, the sensor 110 may include a camera, a ToF sensor, a lidar sensor, etc.

According to an embodiment, if the sensor 110 includes the camera, the at least one processor 150 may control the camera to photograph an image about a space. The at least one processor 150 may obtain position information of the user, direction information thereof, information about a plurality of projectable areas existing in the space, information about various objects such as an obstacle existing in the space based on the image about the space obtained through the camera.

According to an embodiment, if the sensor 110 includes the ToF sensor, the at least one processor 150 may control the ToF sensor to obtain distance information about the space and various objects. The at least one processor 150 may obtain the position information of the user, the direction information thereof, the information about the plurality of projectable areas existing in the space, the information about various objects such as the obstacle existing in the space based on the distance information obtained through the ToF sensor.

According to an embodiment, if the sensor 110 includes the lidar sensor, the at least one processor 150 may control the lidar sensor to obtain the distance information about the space and various objects. The at least one processor 150 may obtain the position information of the user, the direction information thereof, the information about the plurality of projectable areas existing in the space, the information about various objects such as an obstacle existing in the space based on the distance information obtained through the lidar sensor.

In the detailed description, only the case that the sensor 110 includes each of a camera, a ToF sensor, and a lidar sensor is described. However, it is obvious that the sensor 110 may include all of the camera, the ToF sensor, and the lidar sensor or include at least one of the camera, the ToF sensor, or the lidar sensor.

The projection device 120 is a component for projecting an image. The projection device 120 may project an image onto a projection area by using a light source such as a lamp or a LED. For example, the projection device 120 may project light corresponding to an image through a lens and/or a mirror. Accordingly, the projected light may be imaged onto the projection area.

Such projection device 120 may be an ultra-short focus projector, a projection-type projector, or a hybrid projector in which an ultra-short focus method and a projection method are convertible. For example, the hybrid projector may include a plurality of lenses (e.g. ultra short focus-purpose lenses or projection-type lenses) in the projection device 120 and project an image by using the relevant lens corresponding to a change of the projection method.

Further, the projection device 120 may adjust an amount of projected light based on a distance between the projection areas and a surrounding environment. For example, if the surrounding environment is bright, the projection device 120 may project an image with a high amount of light. Otherwise, if the surrounding environment is dark, the projection device 120 may project an image with a relatively low amount of light.

Otherwise, the projection device 120 may project an image with a high amount of light in case of operating in the ultra-short focus method because a distance between the projection area and the electronic apparatus 100 is short. Further, the projection device 120 may output an image with a low amount of light in case of operating in the projection method because the distance is relatively long.

The operations as the above is one example and the amount of light may be calculated in consideration of the surrounding environment, the distance, an area of the projection area, or the like. The projection device 120 may perform projection of the image based on the calculated amount of light.

The moving device 130 is a component for moving the electronic apparatus 100.

According to FIG. 2 as shown, the moving device 130 is shown as a wheel but when implementing, it may be implemented in a caterpillar form. If the electron apparatus 100 is implemented as a drone or the like, the moving device 130 may be implemented as a caterpillar, etc.

On one hand, in the illustrated example, it is shown that the electronic apparatus 100 includes a direct moving device 130 but the moving device 130 may be an additional device. For example, the electronic apparatus 100 may be coupled to a movable device such as a robot cleaner, wherein it may be mounted onto the robot cleaner and operate to control movement of the robot cleaner.

The moving device 130 may adjust a projection direction of the electronic apparatus 100. For example, as shown in FIG. 2, a direction which the projection device 120 views may be adjusted by adjusting a body position of the electronic apparatus 100 or a projection shape may be adjusted by adjusting a position of the lens and the mirror in the projection device 120.

Here, the projection direction means a direction where an image having a projection form is projected and may be referred to as a direction viewed by the electronic apparatus 100, a projection direction, a reflection direction, etc. Hereinafter, for convenience of the description, the expression of changing the projection direction is used but the expression of changing the projection area may be used. Here, the change of the projection area does not mean a change of a screen size in a state that a center point of the projection area is maintained but means the case that the center point of the projection area is changed.

The memory 140 may store data required for implementation of various embodiments of the electronic apparatus 100 according to one or more embodiments of the disclosure. The memory 140 may be implemented as memory embedded in the electronic apparatus 100 according to a use for data storage or may be implemented as memory detachable from the electronic apparatus 100.

For example, data for driving the electronic apparatus 100 is stored in memory embedded in the electronic apparatus 100 and data for an extension function of the electronic apparatus 100 may be stored in memory detachable to the electronic apparatus 100.

The memory 140 may be embedded in the electronic apparatus 100 and may be implemented as at least one of volatile memory (e.g. dynamic RAM (DRAM), static RAM (SRAM), or synchronous dynamic RAM (SDRAM, etc.), non-volatile memory (e.g. one time programmable ROM (OTPROM), programmable ROM (PROM), erasable and programmable ROM (EPROM), electrically erasable and programmable ROM (EEPROM), mask ROM, or flash ROM), flash memory (e.g. NAND flash memory, NOR flash memory, etc.), a hard drive, or a solid state drive (SSD).

Also, the memory 140 may be detachable from the electronic apparatus 100 and may be implemented as a memory card (e.g. a compact flash (CF) card, a secure digital (SD) card, a micro secure digital (Micro-SD) card, a mini secure digital (Mini-SD) card, an extreme digital (xD) card, a multi-media card (MMC), etc.), external memory connectable to a USB port (e.g. USB memory), etc.

The memory 140 may store various instructions required for operations of at least one processor 150. Here, the instructions may include instructions identifying a projection area where projection is possible among surrounding environments, instructions processing a change of the projection area, instructions for a keystone correction, instructions for user voice recognition or voice processing, instructions for projecting an image, etc.

The memory 140 may store map information. Here, the map information refers to information about a space where the electronic apparatus 100 is located and may refer to information about a space divided into a plurality of areas. For example, the electronic apparatus 100 is located at home, it may be assumed as being generated based on a plan view about the relevant house. The electronic apparatus 100 may directly generate this map information and may receive and use the map information generated by another electronic apparatus (e.g. a robot cleaner).

The memory 140 may store information about a plurality of projectable areas and the memory 140 may store information about a change of image quality of an image according to a change of an image projection distance and an image projection angle.

In the present disclosure, “image projection distance” may mean a distance from the projection device 120 to the projection area. For example, the image projection distance may include a distance from a position of a light source included in the projection device 120 to the center point of the projection area.

In the disclosure, “image projection angle” may mean an angle made by a straight line connecting from the projection device 120 to the center point of the projection area and the projection area (a projection surface). For example, if the projection area is a flat surface, it may include an angle made by a straight line connecting from a position of the light source included in the projection device 120 to the center point of the projection area and a flat surface including the projection area.

According to an embodiment, the case that the projection device 120 is the projection-type projector is assumed. In this case, if the image projection distance is very long, the image may become vague. Also, the image projection angle is close to 0°, there is high possibility that distortion of the projected image occurs. In this case, the projection device 120 has no choice but to provide the image having relatively low image quality.

Therefore, to provide the image having high image quality to the user, the electronic apparatus 100 may store information about the change of image quality of the image according to the change of the image projection distance and the image projection angle in the memory 140. In this case, the electronic apparatus 100 may digitize quality of the image as a value from 0 to 100 and store it in the memory 140. For example, the electronic apparatus may store information that if the image projection distance is 3 m, a value of image quality is 50 and if the image projection distance is 5 m, the value of image quality is 70 in the memory 140. As another example, the electronic apparatus may store information that if the image projection angle is 10°, a value of image quality is 10 and if the image projection angle is 70°, the value of image quality is 50 in the memory 140.

In the aforementioned description, only the description that a value of image quality may be digitized from 0 to 100 is made. However, it is obvious that the value of image quality may be calculated as a value of various ranges such as a value from 0 to 100 or a value between 0 and 1 based on an average brightness value of the image, a contrast value, the dispersion of brightness values of the image, the standard deviation of brightness values of the image, and the resolution, etc.

In the aforementioned description, only the case that the projection device 120 is a projection-type projector is described. However, if the projection device 120 is the ultra-short focus projector or the hybrid-type projector, it may also store information about a change of image quality according to a change of the image projection distance and the image projection angle.

At least one processor 150 controls operations of the electronic apparatus 100 overall by executing at least one instruction stored in the memory 140. Specifically, the at least one processor 150 may be connected with each component of the electronic apparatus 100 (e.g. a projection device 120, a moving device 130, and memory 140) to control the operations of the electronic apparatus 100 overall. For example, the at least one processor 150 may be electrically connected to the projection device 120 and memory 140 to control the operations of the electronic apparatus 100 overall.

At least one processor 150 may be implemented as a digital signal processor (DSP) processing a digital signal, a microprocessor, or a time controller (TCON). The disclosure is not limited thereto and it may include one or more of a central processing unit (CPU), a micro controller unit (MCU), a micro processing unit (MPU), a controller, an application processor (AP), a graphics-processing unit (GPU) or a communication processor (CP), or an ARM processor or it may be defined by the relevant terms.

Also, the at least one processor 150 may be implemented as a system on chip (SoC) on which processing algorithm is embedded or a large scale integration (LSI) and it may be implemented as a field programmable gate array (FPGA). Also, the at least one processor 150 may perform various functions by executing computer executable instructions stored in the memory. The at least one processor 150 may include a plurality of processors (e.g. CPU+GPU, CPU+DSP). Hereinafter, for convenience of the description, the at least one processor 150 is commonly referred to as the processor 150.

The processor 150 may obtain the position information and the direction information of the user based on a sensing value of the sensor 110. For example, if the sensor 110 includes a camera and a lidar sensor, the processor 150 may sense the position and the direction of the user based on the sensing value of the camera and the lidar sensor.

The processor 150 may identify a projection area based on the position information and the direction information of the user. As aforementioned, the memory 140 stores information about a plurality of projectable areas. Thus, the processor 150 may identify one projectable area among the plurality of projectable areas based on the position information and the direction information of the user.

According to another example, the processor 150 may identify the projection area based on a type and playback time of a content corresponding to the image. Specifically, if the processor 150 obtains an image output command from the user, it may identify the type, the playback time, and the like of the content corresponding to the image selected by the user. For example, the processor may identify whether the type of the content is a sports game, a movie, a cooking video, or the like, confirm if playback time of the content is 10 minutes, 1 hour, or the like, and identify whether the content requires viewing for a long time or requires viewing only for a short time.

The processor 150 may identify one large area among a plurality of projectable areas existing in the space if the type of the content is the sports game. Also, because if the type of the content is a cooking video, there is high possibility to view the video while the user is cooking, the processor 150 may identify a small projection area existing in the kitchen among a plurality of projection areas.

If the processor 150 determines that the content requires viewing for a long time because playback time of the content is long, the processor may search for a projection area existing in a wall or a ceiling among the plurality of projectable areas. Also, if the processor 150 determines that the content requires viewing only for a short time because playback time of the content is short, it may search for a projection area existing in the bottom or furniture of surroundings of the user.

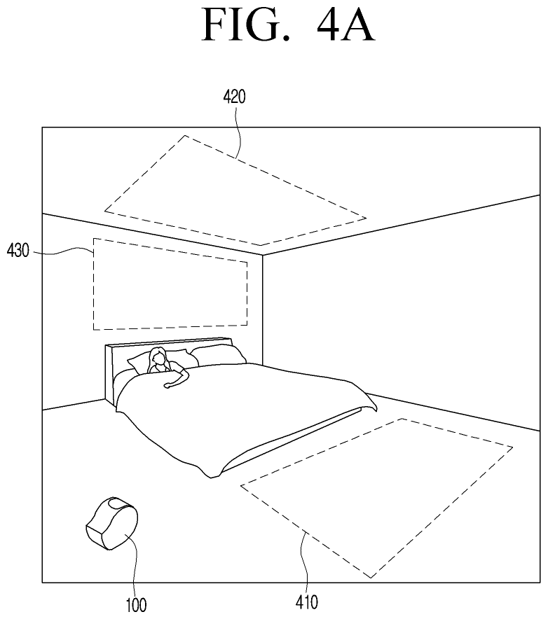

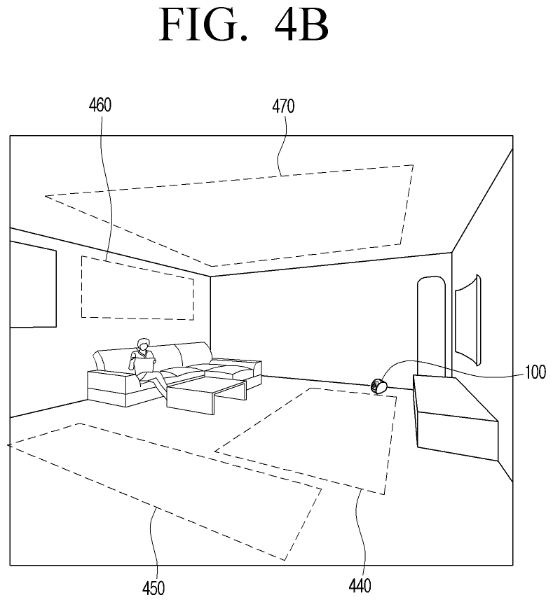

As aforementioned, the processor 150 may identify the projection area based on various methods. The detailed operations to identify the projection area are specifically described in the description of FIGS. 4A and 4B below.

The processor 150 may identify an image projection position based on an image projection distance and an image projection angle with respect to the projection area.

As aforementioned, the memory 140 stores information about a change of image quality according to a change of the image projection distance and the image projection angle and thus the processor 150 may identify a position onto which an image having a maximum image quality with respect to the identified projection area may be projected as the image projection position based on information about a change of image quality.

According to an embodiment, the memory 140 may store the preferred position information corresponding to status of the user. In this case, the processor 150 may obtain status information of the user based on a sensing value of the sensor 110 and may identify the image projection position based on the preferred position information corresponding to the image projection angle, the image projection distance, the status information of the user, and the preferred position information corresponding to the status of the user.

Here, the preferred position information corresponding to the status of the user may include a distance from the user defined with respect to each of a plurality of statuses of the user and information about a direction from the user. For example, if the status of the user is in a state of viewing a TV, the memory 140 may store information of instructing to position it apart from the user at a distance of 4 m and position it in the right direction of the user not to disrupt viewing the TV. As another example, if the status of the user is in a state of moving, the memory 140 may store information of instructing to position it apart from the user at a distance of ‘1 m or more and 2 m or less’ and position it in a perpendicular direction with respect to a moving direction of the user.

According to an embodiment, the processor 150 may identify a plurality of candidate positions where the image projection angle with respect to the identified projection area is within the preset angle range and the image projection distance is within the preset distance range and may identify an image projection position among the plurality of candidate positions based on the status information of the user and the preferred position information corresponding to the status of the user.

Here, the preset angle range may mean a range of the image projection angle in which the projection device 120 may project an image of relatively high image quality and the preset distance range may mean a range in which the projection device 120 may project an image of relatively high quality. According to an embodiment, the preset angle range and the preset distance range may be determined based on information about a change of image quality according to the image projection angle and distance and may be also set by a manufacturer or directly by the user. Also, it is obvious that the preset angle range and the preset distance range may be set as various values according to a projection method and a performance of the projection device 120.

If the status information of the user corresponds to the status of viewing a TV, the processor 150 may identify a position where a distance from the user is about 4 m and which exists on the right side of the user as an image projection position among the identified plurality of candidate positions as the image projection position.

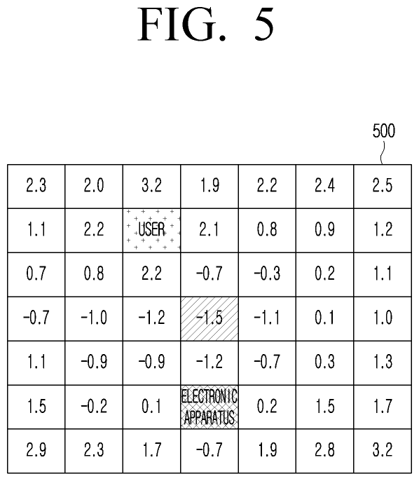

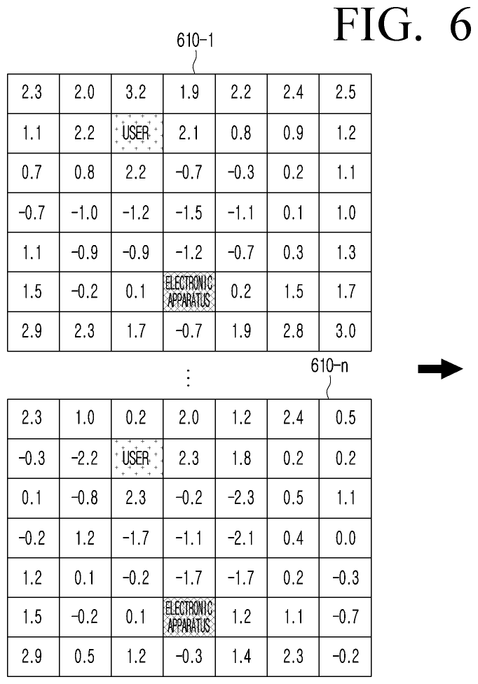

Among the plurality of candidate positions, there may be no candidate position where the distance from the user is about 4 m and which exists on the right side of the user. In this case, an optimum image projection position may be identified by generating the cost map. A method of generating the cost map is specifically described in the description with respect to FIGS. 5 and 6 below.

As aforementioned, the processor 150 may identify the image projection position in consideration of the image projection distance, the image projection angle, and the status of the user and thus may provide an image of high quality at a position preferred by the user.

In FIGS. 4A and 4B below, a specific method by which the electronic apparatus 100 identifies a projection area is described.

FIGS. 4A and 4B are views illustrating a method of identifying an image projection area of an electronic apparatus according to one or more embodiments.

According to FIG. 4A, if the user lies on a bed and views a ceiling, the electronic apparatus 100 may identify a ceiling area 420 among a plurality of projectable areas 410, 420, 430 as the projection area.

The electronic apparatus 100 may identify that the position information of the user corresponds to the bed and the direction information of the user corresponds to a ceiling direction based on the sensing value of the sensor 110. The electronic apparatus 100 may search for the plurality of projectable areas 410, 420, 430 and may identify one area best corresponding to the position information and the direction information of the user among the plurality of projectable areas 410, 420, 430. In this case, the electronic apparatus 100 may identify a projection area corresponding to the position and the direction of the user as the ceiling area 420.

According to an embodiment, even though the position information of the user corresponds to the bed, the electronic apparatus 100 may identify the direction information of the user corresponds to the bottom based on the sensing value of the sensor 110 based on the sensing value of the sensor 110. In this case, the electronic apparatus 100 may identify the bottom area 410 as the projection area.

According to 4B, if the user sits on the sofa, the electronic apparatus 100 may identify a first bottom area 440 among the plurality of projectable areas 440, 450, 460, 470 as the projection area.

The electronic apparatus 100 may identify that the position information of the user corresponds to the sofa and the direction information of the user corresponds to a center bottom direction based on the sensing value of the sensor 110. The electronic apparatus 100 may search for a plurality of projectable areas 440, 450, 460, 470 and may identify one area best corresponding to the position information and the direction information of the user among the plurality of projectable areas 440, 450, 460, 470. In this case, the electronic apparatus 100 may identify a projection area corresponding to the position and the direction of the user as the first bottom area 440.

According to an embodiment, even though the position information of the user corresponds to the sofa, the electronic apparatus 100 may identify the direction information of the user corresponds to the right bottom direction based on the sensing value of the sensor 110. In this case, the electronic apparatus 100 may identify a second bottom area 450 as the projection area.

In the aforementioned description, it is described that the electronic apparatus 100 may also identify only one area as the projection area but may identify one or more areas as the candidate projection area.

In the aforementioned description, it is described that the electronic apparatus 100 may identify the projection area based on the position information and the direction information of the user but it is merely one example, wherein it is obvious that the projection area may be identified according to the status information of the user. For example, if the status information of the user corresponds to a state of cooking, the electronic apparatus 100 may search for a projectable area existing in the space where the cooking is done to identify the projection area.

As aforementioned, if the electronic apparatus 100 identifies the projection area based on various information, it may identify the image projection position for projecting an image onto the identified projection area. Specific operations for identifying the image projection position are specifically described in the description with respect to FIGS. 5 and 6 below.

FIG. 5 is a view illustrating a method of generating a cost map of an electronic apparatus according to one or more embodiments.

According to FIG. 5, the electronic device 100 may generate a cost map 500 including a plurality of costs and a grid corresponding to each of the plurality of costs.

In the disclosure, the “cost map” may mean a map generated by dividing a space where the electronic apparatus 100 may move into the plurality of grids and assigning costs onto each of the plurality of grids. For example, the cost map may be implemented as a map in which the electronic apparatus 100 divides the space into 5×5 grids and assigns costs from 10 to −10 onto each of 25 grids.

The cost map may be substituted with and referred to as various expressions indicating the same/similar concept. For example, it may be substituted with various expressions “cost grid map”, “cost graph”, “expense graph”, “cost chart”, “cost matrix”, “map for cost comparison”, “cost chart”, “cost analysis map”, “cost analysis matrix”, “cost comparison map”, etc. In the disclosure, it may be commonly referred to as ‘cost map’ for convenience of the description.

The electronic apparatus 100 may obtain information about a surrounding space of the user based on the sensing value of the sensor 110 or obtain the information about the space of the surrounding space of the user from an external device (e.g. a robot cleaner), and then may store the information about the surrounding space of the user in the memory 140.

Here, the information about the surrounding space of the user may include map information about the surrounding space of the user, information about an obstacle, information about moving time, etc.

The electronic apparatus 100 may generate a cost map 500 including a plurality of costs and grids respectively corresponding to the plurality of costs based on the image projection distance, the image projection angle, and the information about the surrounding space of the user.

According to an embodiment, the electronic apparatus 100 may shape the surrounding space of the user in a map form in which the surrounding space of the user is divided into a plurality of grids having the same areas based on the map information about the surrounding space of the user. Also, the electronic apparatus 100 may generate the cost map 500 by assigning costs onto each of the plurality of grids included in the map where the surrounding space of the user is shaped.

To determine costs to be assigned onto each of the plurality of grids, the electronic apparatus 100 may calculate the image projection distance and the image projection angle from a position corresponding to each of the plurality of grids to the identified projection area, respectively.

According to an embodiment, the electronic apparatus 100 may assign costs to become small in an order from a grid with a small difference between the image projection distance calculated from a position corresponding to each of the plurality of grids and a preset distance to a grid with a large difference. As another example, the electronic apparatus 100 may assign costs to become large onto grids in an order from a grid with a small angle difference between the image projection angle calculated from a position corresponding to each of the plurality of grids and a preset angle to a grid with a large difference.

Here, the preset distance may mean a distance value in which the projection device 120 may project an image having high image quality. Also, the preset angle may mean an angle value in which the projection device 120 may project an image having high image quality. Also, it is obvious that the preset angle range and the preset distance range may be set as various values according to a projection method and a performance of the projection device 120. For example, if the projection device 120 is the ultra-short focus projector, the preset distance may be 50 cm and the preset angle may be 20° but if the projection device 120 is the projection-type projector, the preset distance may be 4 m and the preset angle may be 90°.

To determine costs assigned to each of the plurality of grids, the electronic apparatus 100 may use information about the surrounding space of the user.

According to an embodiment, the electronic apparatus 100 may calculate the number and a size of an obstacle existing in surroundings of a position corresponding to each of the plurality of grids based on information about the obstacle in the space. The electronic apparatus 100 may assign costs to become small onto grids in an order from a grid having few obstacles existing in the surroundings to a grid having many obstacles. As another example, the electronic apparatus 100 may assign costs to become small onto grids in an order from a grid having a small obstacle existing in the surroundings to a grid having a large obstacle.

To determine costs assigned to each of the plurality of grids, the electronic apparatus 100 may use information about movement time.

According to an embodiment, the electronic apparatus 100 may calculate time consumed for moving to a position corresponding to each of the plurality of grids based on information about movement time. The electronic apparatus 100 may assign costs to become small onto grids in an order from a grid having little movement time to a grid having much movement time.

According to another embodiment, it is obvious that the electronic apparatus 100 may assign costs onto each of the plurality of girds based on various information and methods such that it assigns a small cost onto a grid corresponding to a position where a steep slope exists or a sill exists and assigns a large cost onto a grid corresponding to a position of the flat bottom based on the map information about the surrounding space.

As aforementioned, the electronic apparatus 100 may generate the cost map 500 by assigning costs onto each of the plurality of grids through various methods and may identify the smallest cost among the plurality of costs and identify a position corresponding to the grid including the smallest cost as the image projection position. If the image projection position is identified, the electronic apparatus 100 may control the moving device 130 to move to the image projection position.

As shown in FIG. 5, in the cost map 500 generated by the electronic apparatus 100, the smallest cost is ‘−1.5’, wherein the electronic apparatus may control the moving device 130 to move to a position corresponding to a grid including the cost of ‘−1.5’.

FIG. 5 illustrates a cost map in a lattice shape of 7×7 but it is merely one example. It is obvious that the cost map may be generated in various shapes such as a lattice form of 8×8 or 3×3. Also, it is obvious that the electronic apparatus 100 may divide the space into grids having various forms such as not only the lattice form but also a circle, a triangle, or the like to generate the cost map.

Also, in the aforementioned description, the electronic apparatus 100 identifies a position corresponding to a grid including the smallest cost as the image projection position. However, it is obvious that the electronic apparatus may identify a position corresponding to a grid including the large cost as the image projection position. If the electronic apparatus 100 identifies a position corresponding to a grid including the largest cost as the image projection position, it may assign the costs in a direction opposite to the aforementioned method. For example, the electronic apparatus 100 may assign costs to become large onto grids in an order from a grid with a small difference between the image projection distance and a preset distance to a grid with a large difference.

As aforementioned, the electronic apparatus 100 may determine costs based on various information. The electronic apparatus 100 may generate the cost map by assigning a weight value to the costs determined based on various information. In respect to this, it is specifically explained in the description of FIG. 6.

FIG. 6 is a view illustrating a method of generating a cost map based on a plurality of layers of an electronic apparatus according to one or more embodiments.

According to FIG. 6, the electronic apparatus 100 may generate a cost map 620 by assigning a weight value to each of n layers (610-1, . . . , 610-n). In this description, for convenience of the description, a cost included in the first layer 610-1 is referred to as a first cost, a cost included in the second layer is referred to as a second cost, and a cost included in a nth layer 610-n is referred to as a nth cost. Also, a weight value assigned to the first layer 610-1 is referred to as a first weight value, a weight value assigned to the second layer is referred to as a second weight value, and a weight value assigned to the nth layer 610-n is referred to as a nth weight value.

According to an embodiment, the electronic apparatus 100 may generate the cost map 620 by assigning a weight value to each of two layers generated based on the image projection distance and the image projection angle. In this case, the electronic apparatus 100 may generate the first layer 610-1 in which a first cost decreases from a grid of the plurality of grids having a small difference between the image projection distance and a preset distance to a grid of the plurality of grids having a large difference between the image projection distance and the preset distance. Also, the electronic apparatus 100 may generate a second layer in which a second cost decreases from a grid of the plurality of grids having a small difference between the image projection angle and a preset angle to a grid of the plurality of grids having a large difference between the image projection angle and a preset angle.

The electronic apparatus 100 may multiply the first cost by the first weight value and multiply the second cost by the second weight value. The electronic apparatus 100 may generate the cost map 620 by adding the first cost multiplied by the first weight value to the second cost multiplied by the second weight value.

Here, the first weight value and the second weight value may be the same value and may be different values. For example, if the projection direction of the projection device 120 is fixed, the image projection angle must have the fixed value. Accordingly, the second layer generated based on the image projection angle has a more important meaning and thus the second weight value may have a greater value than the first weight value. As another example, if the user wants to be offered a large image, the image projection distance must be long. Accordingly, the first layer may have a more important meaning than the second layer. In this case, the first weight value may have a greater value than the second weight value.

As aforementioned, the electronic apparatus 100 may generate the cost map suitable for a circumstance by differently assigning a size of a weight value according to various circumstances such as a purpose of the image projection and a type of the projection device 120.

According to an embodiment, the electronic apparatus 100 may generate a layer where the cost are given to become small onto grids in an order from a gird having fewer obstacles existing in the surroundings to a gird having many obstacles based on information about the obstacles existing in the space. Also, the electronic apparatus 100 may generate a layer where the costs are given to become small onto grids in an order from a gird having a small obstacle existing in the surroundings to a gird having a large obstacle.

According to another embodiment, the electronic apparatus 100 may respectively calculate time consumed for moving to a position corresponding to each of the plurality of grids based on information about movement time and may generate a layer where the costs are given to become small in an order from a gird having little movement time to a grid having much movement time.

According to another embodiment, the electronic apparatus 100 may generate a layer where small costs are given onto girds corresponding to a position where a steep slope exists or a sill exists and large costs are given onto grids corresponding to a position of the flat bottom.

According to still another embodiment, the electronic apparatus 100 may generate a layer based on status information of the user and preferred position information corresponding to the status of the user. Again, the electronic apparatus 100 may assign costs to become small onto grids in an order from a grid corresponding to a position close to the preferred position of the user to a grid corresponding to a position apart therefrom.

Specifically, if the status of the user identified by the electronic apparatus 100 corresponds to a state of viewing a TV and the preferred position information corresponding to a state of viewing the TV corresponds to ‘a position 4 m away from the user in a right direction’, the electronic apparatus 100 may generate a layer where the smallest cost is given onto a gird corresponding to ‘a position 4 m away from the user in a right direction’ and larger costs are given onto grids as being apart from ‘a position 4 m away from the user in a right direction’.

The aforementioned method of generating the layer is merely one example, wherein it is obvious that the electronic apparatus 100 may generate a plurality of layers based on various information and methods.

As aforementioned, the electronic apparatus 100 may generate a plurality of layers 610-1, . . . , 610-n based on various information and may generate a final cost map 620 by multiplying costs included in each of the plurality of layers by a weight value and adding all the costs multiplied by the weight value.

According to an example, if the electronic apparatus 100 determines that a cost of the layer generated based on the status information of the user and the preferred position information corresponding to the status of the user is the most important value, the electronic apparatus may determine a weight value assigned to the relevant cost as the largest value.

The electronic apparatus 100 may identify the image projection position based on the final cost map 620. As shown in FIG. 6, if ‘−2.3’ is the smallest cost, the electronic apparatus 100 may identify a position corresponding to a grid including the cost of ‘−2.3’ as the image projection position.

In the detailed description, only the description that the electronic apparatus 100 may identify a position corresponding to a grid including the smallest cost as the image projection position is made but it is merely one example. Even though the number of grids including the smallest cost are plural numbers, the electronic apparatus 100 may identify one image projection position and move to the identified image projection position.

It is assumed that in the cost map generated by the electronic apparatus 100, ‘−2.3’ is the smallest cost and a grid including the cost of ‘−2.3’ is plural numbers. According to an embodiment, the electronic apparatus 100 may identify a position corresponding to a grid closest to a grid corresponding to a position of the user among the plurality of grids as the image projection position.

According to another embodiment, the electronic apparatus 100 may select randomly one grid among a plurality of grids including the smallest cost and may identify a position corresponding to the selected grid as the image projection position. According to another embodiment, the electronic apparatus 100 may select a grid corresponding to a position closest to the identified projection area and identify a position corresponding to the selected grid as the image projection position.

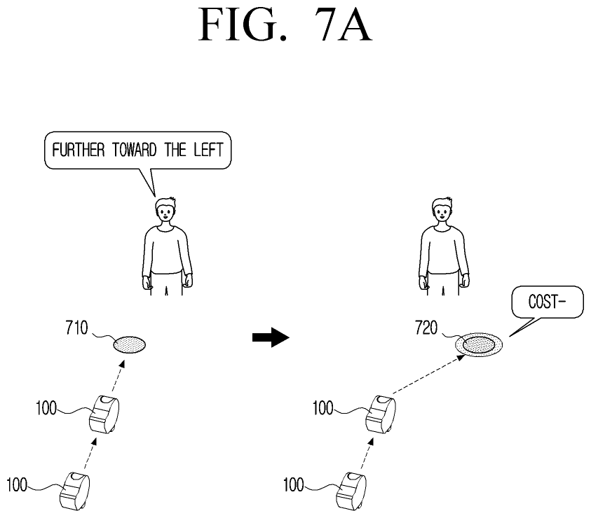

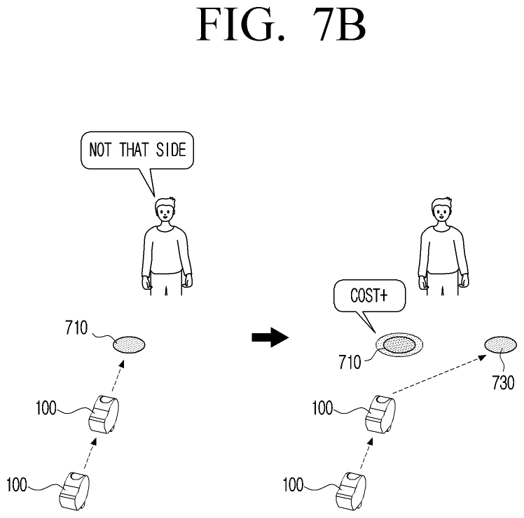

The electronic apparatus 100 may identify the projection position based on a plurality of costs included in the final cost map 620 as aforementioned. The plurality of costs included in the final cost map 620 may be changed by feedback of the user. Accordingly, specific operations in which the image projection position of the electronic apparatus 100 is changed by the feedback of the user are specifically described in the description part with respect to FIGS. 7A and 7B below.

FIGS. 7A and 7B are views illustrating an operating method based on feedback of a user of an electronic apparatus according to one or more embodiments.

According to FIG. 7A, the electronic apparatus 100 may change the image projection position from a first position 710 to a second position 720 based on the feedback of the user.

According to an embodiment, the electronic apparatus 100 may obtain the feedback of the user with respect to movement to the image projection position. If the sensor 110 includes a camera, the electronic apparatus 100 may obtain the feedback of the user based on the image photographed by the camera. If the electronic apparatus 100 includes a microphone, the electronic apparatus 100 may obtain the feedback of the user through the microphone.

If the electronic apparatus 100 obtains positive feedback of the user with respect to movement to the image projection position, it may control the moving device 130 to move to the image projection position and if the electronic apparatus obtains negative feedback of the user with respect to movement to the image projection position, it may change the image projection position.

Here, the feedback of the user may include a voice of the user, a gesture of the user, etc. For example, the feedback of the user may include a voice such as “further toward the left” or “not that side”. Also, the feedback of the user may include a hand gesture of the user indicating the left or a hand gesture of the user indicating “OK”.

According to an embodiment, if the electronic apparatus 100 obtains negative feedback of the user with respect to movement to the image projection position, it may update costs of the cost map, identify the smallest cost among the plurality of costs included in the updated cost map, and change the image projection position to a position corresponding to a grid including the smallest cost.

Specifically, if the electronic apparatus 100 obtains negative feedback of the user of “further toward the left” while identifying the first position 710 as the image projection position and controlling the moving device 130 to move to the first position 710, the electronic apparatus 100 may update costs of the cost map by reducing costs of part corresponding to the left side of the first position in the cost map. The electronic apparatus 100 may change the second position 720 corresponding to the grid including the smallest cost in the updated cost map as the image projection position.

According to FIG. 7B, the electronic apparatus 100 may change the image projection position from the first position 710 to a third position 730 based on the feedback of the user.

Specifically, if the electronic apparatus 100 obtains negative feedback of the user of “not that side” while identifying a first position 710 as the image projection position and controlling the moving device 130 to move to the first position, the electronic apparatus 100 may update costs of the cost map by increasing costs of the grid corresponding to the first position in the cost map. The electronic apparatus 100 may change the third position 730 corresponding to the grid including the smallest cost in the updated cost map as the image projection position.

As aforementioned, the electronic apparatus 100 may obtain the feedback of the user through the camera. In this case, the electronic apparatus 100 may obtain the feedback of the user by using an image recognition technology with respect to the photographed image.

As aforementioned, the electronic apparatus 100 may obtain the feedback of the user through the microphone. In this case, the electronic apparatus 100 may obtain voice feedback of the user by using a STT technology and/or a NLP technology.

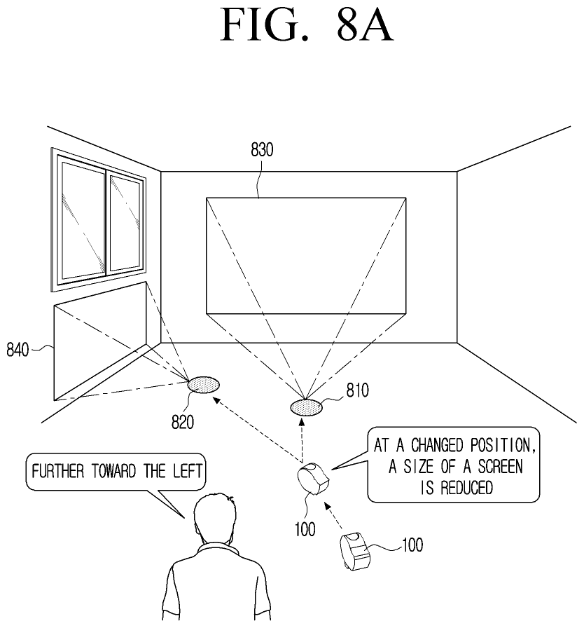

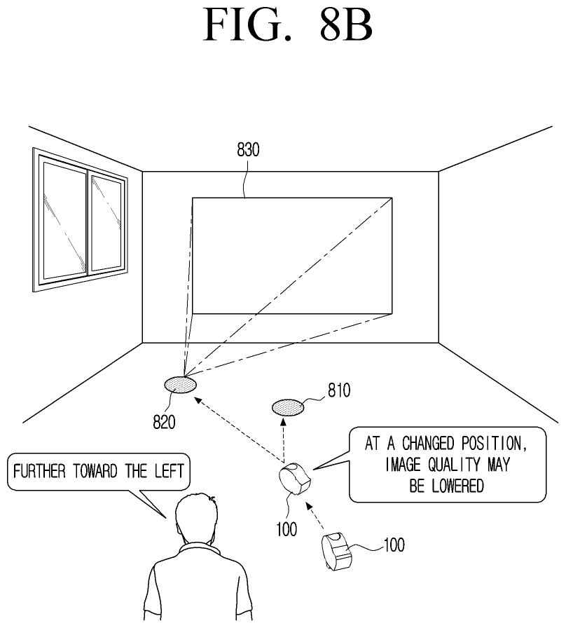

As aforementioned, the electronic apparatus 100 may achieve an effect of reflecting the feedback of the user on the cost map and identifying a suitable image projection position. If the image projection position is changed based on the feedback of the user, image quality of the image may be changed. In this case, the electronic apparatus 100 may provide information about a change of the image quality of the image to the user, wherein it may be specifically described in FIGS. 8A and 8B below.

FIGS. 8A and 8B are views illustrating a method of providing information about a change of image quality of an electronic apparatus according to one or more embodiments.

According to FIG. 8A, if the image projection position is changed based on the feedback of the user and thus a size of the projection image is changed, the electronic apparatus 100 may provide information about the change in the size of the projection image to the user.

According to an embodiment, if the image projection position is changed, the electronic apparatus 100 may compare image quality of the projection image at a position 810 before changing to image quality of the projection image at a position 820 after changing and may provide information about a change of the image quality of the projection image.

Specifically, if the image projection position is changed by the feedback of the user, the projection area may be also changed. In this case, the size of the projection area 830 before changing and the size of the projection area 840 after changing may be different and a size of the image projected by the electronic apparatus 100 may be also changed. Because the user may not want to change the size of the image, the electronic apparatus 100 may output and provide a voice “a screen size is reduced at a changed position” to the user.

In FIG. 8A, only the case where the size of the projection image is reduced based on a change of the image projection position is described. However, it is obvious that even though the size of the projection image is large, it is possible to provide the information about the change of the size to the user.

According to FIG. 8B, if the image projection position is changed based on the feedback of the user and thus there may be possibility to lower the image quality of the projection image, the electronic apparatus 100 may provide the information about the change in the image quality to the user.

According to an embodiment, only the image projection position of the electronic apparatus 100 is changed by the feedback of the user and the projection area may not be changed. In this case, the image projection angle and the image projection distance at the position 810 before changing may be different from the image projection angle and the image projection distance at the position 820 after changing.

Specifically, since the image projection angle becomes small due to the change of the image projection position, possibility that distortion of the projection image occurs may become great. In this case, the electronic apparatus 100 may output and provide a voice “image quality may be lowered at a changed position” or “distortion of the projection image may occur” to the user.

FIGS. 8A and 8B illustrate only that the electronic apparatus 100 outputs an audio signal and provides information about a change of image quality to the user but it is merely one example. It obvious that the electronic apparatus 100 may project an image about the change of image quality or transmit information about the change of image quality to an external device such as a display device, thereby providing information about the change of image quality to the user.

As aforementioned, if the image projection position of the electronic apparatus 100 is changed based on the feedback of the user, the electronic apparatus 100 may provide the position after changing and information about the projection image after changing to the user. Accordingly, the user may obtain the information about the changed image projection position and may provide the feedback one more time with respect to the change of the image projection position of the electronic apparatus 100.

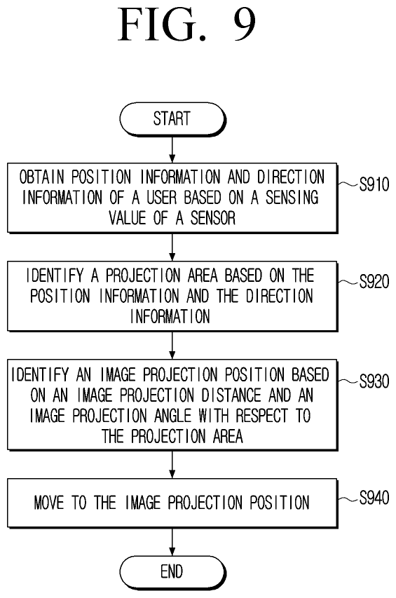

FIG. 9 is a flow chart illustrating a method of moving to an image projection position of an electronic apparatus according to one or more embodiments.

According to FIG. 9, the electronic apparatus 100 may obtain position information and direction information of the user based on a sensing value of a sensor (S910).

Then, the electronic apparatus 100 may identify the projection area based on the position information and the direction information (S920). Here, the electronic apparatus 100 may identify the projection area based on information about the plurality of projectable areas. The electronic apparatus 100 may photograph the surrounding space of the user and obtain information about the plurality of projectable areas in the surrounding space based on the photographed surrounding space.

Then, the electronic apparatus 100 may identify the image projection position based on the image projection distance and the image projection angle with respect to the projection area (S930). Here, the electronic apparatus 100 may generate a cost map including a plurality of costs and grids respectively corresponding to the plurality of costs based on the image projection distance, the image projection angle, and information about the surrounding space of the user, identify the smallest cost among the plurality of costs, and then identify a position corresponding to the grid including the smallest cost as the image projection position.

Here, the electronic apparatus 100 may generate a first layer having a first cost that decreases from a grid of the plurality of grids having a small difference between the image projection distance and a preset distance to a grid of the plurality of grids having a large difference between the image projection distance and the preset distance, generate a second layer having a second cost that decreases from a grid of the plurality of grids having a small difference between the image projection angle and a preset angle to a grid of the plurality of grids having a large difference between the image projection angle and the preset angle, and generate the cost map by assigning a weight value to each of the first layer and the second layer.

Then, the electronic apparatus 100 may move to the identified image projection position (S940).

As aforementioned, even though the user directly indicates the image projection position, the method of controlling the electronic apparatus 100 according to an embodiment may directly identify the image projection position based on various information such as position information of the user, direction information thereof, the image projection distance, or the image projection angle and may move to the identified image projection position, thereby providing convenience and an image having high quality to the user.

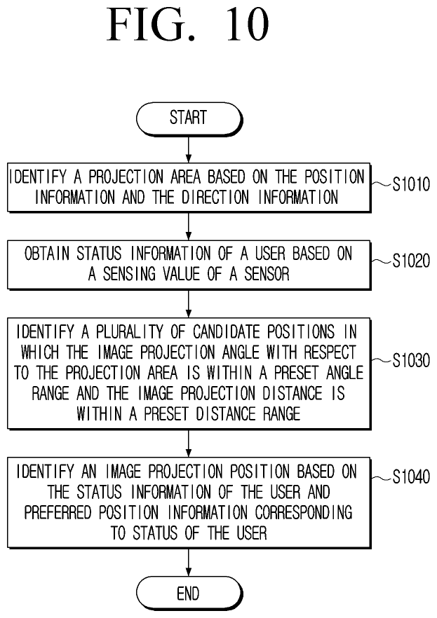

FIG. 10 is a flow chart illustrating a method of identifying an image projection position of an electronic apparatus according to one or more embodiments.

According to FIG. 10, the electronic apparatus 100 may identify projection areas based on position information and direction information (S1010).

Then, the electronic apparatus 100 may obtain status information of the user based on a sensing value of the sensor (S1020). According to an embodiment, the electronic apparatus 100 may obtain status information that the user is viewing a TV.

Then, the electronic apparatus 100 may identify a plurality of candidate positions where the image projection angle with respect to the identified projection area is within the preset angle range and the image projection distance is within the preset distance range (S1030). According to an embodiment, the electronic apparatus 100 may identify a plurality of candidate positions where the image projection angle is between 50° and 90° and the image projection distance is from 2 m to 4 m.

Then, the electronic apparatus 100 may identify the image projection position based on the status information of the user and the preferred position information corresponding to the status of the user (S1040). According to an embodiment, if the status of the user corresponds to a state of viewing a TV, the electronic apparatus 100 may identify a position where a distance from the user is about 4 m and which exists on the right side of the user as the image projection position among the identified plurality of candidate positions based on the preferred position information corresponding to the state of viewing the TV.

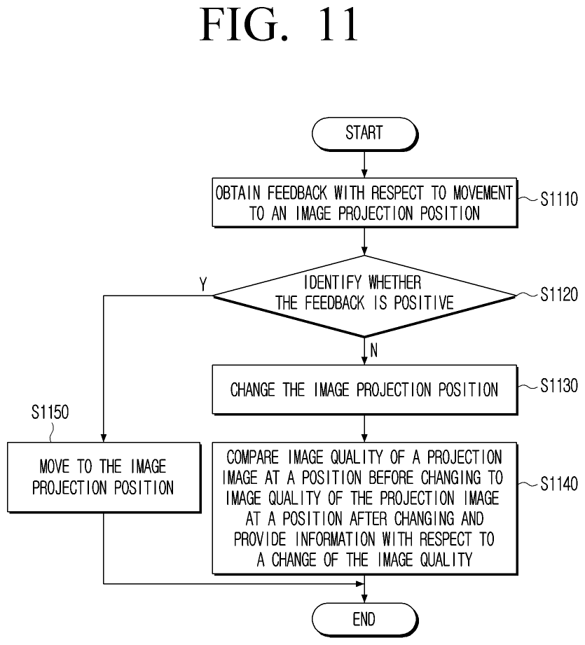

As aforementioned, the method of controlling the electronic apparatus 100 according to an embodiment of the disclosure may identify the image projection position corresponding to the status of the user based on the status information of the user and the preferred position information corresponding to the status of the user, thereby projecting an image at the position preferred by the user even if the user does not input instructions with respect to movement of the position. Also, the electronic apparatus 100 may obtain feedback with respect to the image projection position from the user and change the image projection position based on the obtained feedback. The method of changing the image projection position is specifically described in the description part with respect to FIG. 11 below.

FIG. 11 is a flow chart illustrating operations about feedback of a user of an electronic apparatus according to one or more embodiments.

According to FIG. 11, the electronic apparatus 100 may obtain the feedback of the user with respect to movement to the image projection position (S1110). Here, the feedback of the user may be obtained through a microphone or a camera.

Then, the electronic apparatus 100 may identify whether the feedback of the user is positive (S1120). According to an embodiment, if the electronic apparatus 100 obtains a voice of the user “not that side” through the microphone, it may identify the feedback of the user as negative feedback. According to an embodiment, if the electronic apparatus 100 obtains a voice of the user “further toward the left” through the microphone, it may identify the feedback of the user as the negative feedback. According to an embodiment, if the electronic apparatus 100 obtains a gesture of the user “OK” through the camera, it may identify the feedback of the user as positive feedback.

Then, if the electronic apparatus 100 identifies the feedback of the user as being negative (S1120: N), it may change the image projection position (S1130). According to an embodiment, the electronic apparatus 100 may update costs of the cost map, identify the smallest cost among a plurality of costs included in the updated cost map, and change the image projection position to a position corresponding to a grid including the smallest cost.

Then, the electronic apparatus 100 may compare image quality of the projection image at a position before changing to image quality of the projection image at a position after changing and may provide information about a change of the image quality (S1140). According to an embodiment, the electronic apparatus 100 may provide information about a change of a size of the projection image and provide information about distortion occurrence of the projection image.

Then, if the electronic apparatus 100 identifies the feedback of the user as being positive (S1120: Y), it may move to the image projection position (S1150).

Various methods described in FIGS. 9 to 11 may be performed by the electronic apparatus having a configuration shown in FIG. 3 but are not necessarily limited thereto, wherein the methods may be performed by the electronic apparatus having various configurations.

FIGS. 9 to 11 map sequences with respect to all steps for convenience of the description. However, it is obvious that sequences of operations and like, which are not related to sequences or may be performed in parallel are not necessarily limited to the relevant sequences.

As the above, the electronic apparatus according to the disclosure may identify a suitable image projection position in various circumstances and move to the image projection position. Accordingly, the user may view an image of high image quality by directly moving or without changing a position of the projection device.

The aforementioned methods according to at least part of various examples of the disclosure may be implemented as an application installable in the existing electronic apparatus.

Also, the aforementioned methods according to at least part of various examples of the disclosure may be implemented only with a software upgrade or a hardware upgrade with respect to the existing electronic apparatus.

Also, it is possible to perform the aforementioned methods according to at least part of various examples of the disclosure through an embedded server included in the electronic apparatus or the external server of at least one of the electronic apparatuses.

According to an embodiment of the disclosure, various examples described above may be implemented as software including instructions stored in machine-readable storage media, which can be read by a machine (e.g. a computer). The machine refers to a device which calls instructions stored in storage media and is operable according to the called instructions, wherein it may include the electronic apparatus (e.g. a display device A) according to the disclosed embodiments. If the instructions are executed by a processor, the processor may perform a function corresponding to the instructions directly or by using the other components under control of the processor. The instructions may include a code generated or executed by a compiler or an interpreter. A machine-readable storage medium may be provided in a form of a non-transitory storage medium. Here, the term ‘non-transitory storage medium’ only means that the storage medium is a tangible device and does not include a signal (e.g. an electromagnetic wave), wherein the term does not distinguish a case where data is stored semi-permanently and a case where data is stored temporarily in the storage medium. For example, the ‘non-transitory storage medium’ may include a buffer where data is temporarily stored. According to an embodiment, a method according to various examples disclosed in the disclosure may be provided to be included in a computer program product. The computer program product may be traded between a seller and a buyer as goods. The computer program product may be distributed on-line in a form of the machine-readable storage medium (e.g. compact disc read only memory (CD-ROM)) or distributed (e.g. downloaded or uploaded) via an application store (e.g. play store™) or directly between two user devices (e.g. smart phones). In the case of on-line distribution, at least part of the computer program product (e.g. a downloadable app) may be stored at least temporarily or may be generated temporarily in the machine-readable storage media such as memory of a server of a manufacturer, a server of an application store, or a relay server.

The various examples of the disclosure may be implemented as software including instructions stored in the machine-readable storage media, which can be read by the machine (e.g. a computer). The machine refer to a device which calls instructions stored in the storage medium and is operable according to the called instructions, wherein it may include an electronic apparatus (e.g. an electronic apparatus 100) according to the disclosed embodiments.

If the aforementioned instructions are executed by a processor, the processor may perform a function corresponding to the instructions directly or by using the other components under control of the processor. The instructions may include a code generated or executed by a compiler or an interpreter.

Although certain exemplary embodiments are illustrated and described above, the present disclosure is not limited to the certain embodiments, various applications may of course be performed by those skilled in the art without deviating from what is claimed in the scope of claims, and such applications should not be understood separately from the technical idea or prospects herein.

What is claimed is:

1. An electronic apparatus comprising:
a sensor;
a projection apparatus configured to project a projection image;
a moving device comprising at least one actuator and configured to move the electronic apparatus;
memory storing at least one instruction; and
at least one processor configured to execute the at least one instruction,
wherein the at least one instruction, when executed by the at least one processor, causes the electronic apparatus to:
obtain position information of a user and direction information of the user based on a sensing value of the sensor;
identify a projection area based on the position information and the direction information;
identify an image projection position of the electronic apparatus based on an image projection distance and an image projection angle with respect to the projection area; and
control the moving device to move to the image projection position.

2. The electronic apparatus of claim 1, wherein the memory stores information about a surrounding space of the user, and
wherein the at least one instruction, when executed by the at least one processor, causes the electronic apparatus to:
generate a cost map comprising a plurality of costs and a plurality of grids corresponding to each of the plurality of costs based on the image projection distance, the image projection angle, and the information about the surrounding space; and
identify the image projection position as a position corresponding to a grid of the plurality of grids having a smallest cost among the plurality of costs.

3. The electronic apparatus of claim 2, wherein the at least one instruction, when executed by the at least one processor, causes the electronic apparatus to:
generate a first layer having a first cost that decreases from a grid of the plurality of grids having a first difference between the image projection distance and a preset distance to a grid of the plurality of grids having a second difference between the image projection distance and the preset distance, the second difference being larger than the first difference;
generate a second layer having a second cost that decreases from a grid of the plurality of grids having a third difference between the image projection angle and a preset angle to a grid of the plurality of grids having a fourth difference between the image projection angle and the preset angle, the fourth difference being larger than the third difference; and
generate the cost map by assigning a weight value to each of the first layer and the second layer.

4. The electronic apparatus of claim 1, wherein the memory stores preferred position information corresponding to status of the user, and
wherein the at least one instruction, when executed by the at least one processor, causes the electronic apparatus to:
obtain status information of the user based on the sensing value of the sensor;
identify a plurality of candidate positions in which the image projection angle with respect to the projection area is within a preset angle range and the image projection distance is within a preset distance range; and
identify the image projection position among the plurality of candidate positions based on the status information of the user and the preferred position information.

5. The electronic apparatus of claim 1, wherein the sensor comprises a camera, and
wherein the at least one instruction, when executed by the at least one processor, causes the electronic apparatus to:
control the moving device to move to the image projection position based on feedback of the user with respect to movement to the image projection position obtained through the camera.

6. The electronic apparatus of claim 5, wherein the at least one instruction, when executed by the at least one processor, causes the electronic apparatus to:
based on the image projection position being changed, compare an image quality of the projection image at a position before changing to an image quality of the projection image at a position after changing, and
provide information about a change in image quality of the projection image based on the comparison.

7. The electronic apparatus of claim 1, further comprising a microphone,
wherein the at least one instruction, when executed by the at least one processor, causes the electronic apparatus to:
control the moving device to move to the image projection position based on feedback of the user with respect to movement to the image projection position obtained through the microphone.

8. The electronic apparatus of claim 2, wherein the at least one instruction, when executed by the at least one processor, causes the electronic apparatus to:
update the plurality of costs of the cost map based on feedback of the user with respect to movement of the image projection position being obtained; and
identify the smallest cost among the plurality of costs in the updated cost map and change the image projection position to a position corresponding to a grid comprising the smallest cost in the updated cost map.

9. The electronic apparatus of claim 1, wherein the at least one instruction, when executed by the at least one processor, causes the electronic apparatus to:
identify the projection area based on a type of contents corresponding to the projection image and a playback time.

10. The electronic apparatus of claim 1, wherein the sensor includes a camera, and
wherein the at least one instruction, when executed by the at least one processor, causes the electronic apparatus to:
control the camera to photograph a surrounding space of the user; and
obtain information about a plurality of projectable areas within the surrounding space based on the photographed surrounding space.

11. A method of controlling an electronic apparatus, the method comprising:
obtaining position information of a user and direction information of the user based on a sensing value of a sensor;
identifying a projection area based on the position information and the direction information;
identifying an image projection position of the electronic apparatus based on an image projection distance and an image projection angle with respect to the projection area; and
moving to the image projection position.

12. The method of claim 11, wherein the identifying the image projection position comprises:
generating a cost map comprising a plurality of costs and a plurality of grids corresponding to each of the plurality of costs based on the image projection distance, the image projection angle, and the information about a surrounding space of the user; and
identifying the image projection position as a position corresponding to a grid of the plurality of grids having a smallest cost among the plurality of costs.

13. The method of claim 12, wherein the generating the cost map comprises:
generating a first layer having a first cost that decreases from a grid of the plurality of grids having a first difference between the image projection distance and a preset distance to a grid of the plurality of grids having a second difference between the image projection distance and the preset distance, the second difference being larger than the first difference;
generating a second layer having a second cost that decreases from a grid of the plurality of grids having a third difference between the image projection angle and a preset angle to a grid of the plurality of grids having a fourth difference between the image projection angle and the preset angle, the fourth difference being larger than the third difference; and
generating the cost map by assigning a weight value to each of the first layer and the second layer.

14. The method of claim 11, wherein the identifying the image projection position comprises:
obtaining status information of the user based on the sensing value of the sensor;
identifying a plurality of candidate positions in which the image projection angle with respect to the projection area is within a preset angle range and the image projection distance is within a preset distance range; and
identifying the image projection position based on the status information of the user and preferred position information corresponding to status of the user.

15. A non-transitory computer readable recording medium storing computer instructions that when executed by a processor of an electronic apparatus, cause the electronic apparatus to:
obtain position information of a user and direction information of the user based on a sensing value of a sensor;
identify a projection area based on the position information and the direction information;
identify an image projection position of the electronic apparatus based on an image projection distance and an image projection angle with respect to the projection area; and
move to the image projection position.

16. A non-transitory computer readable recording medium of claim 15,
wherein the identifying the image projection position comprises:
generating a cost map comprising a plurality of costs and a plurality of grids corresponding to each of the plurality of costs based on the image projection distance, the image projection angle, and the information about a surrounding space of the user; and
identifying the image projection position as a position corresponding to a grid of the plurality of grids having a smallest cost among the plurality of costs.

17. A non-transitory computer readable recording medium of claim 16,
wherein the generating the cost map comprises:
generating a first layer having a first cost that decreases from a grid of the plurality of grids having a first difference between the image projection distance and a preset distance to a grid of the plurality of grids having a second difference between the image projection distance and the preset distance, the second difference being larger than the first difference;
generating a second layer having a second cost that decreases from a grid of the plurality of grids having a third difference between the image projection angle and a preset angle to a grid of the plurality of grids having a fourth difference between the image projection angle and the preset angle, the fourth difference being larger than the third difference; and
generating the cost map by assigning a weight value to each of the first layer and the second layer.

18. A non-transitory computer readable recording medium of claim 15,
wherein the identifying the image projection position comprises:
obtaining status information of the user based on the sensing value of the sensor;
identifying a plurality of candidate positions in which the image projection angle with respect to the projection area is within a preset angle range and the image projection distance is within a preset distance range; and
identifying the image projection position based on the status information of the user and preferred position information corresponding to status of the user.
